(19) United States
(12) Patent Application Publication
(10) Pub. No.: US 2002/0172197 A1
(43) Pub. Date: Nov. 21, 2002

(54) System interconnect with minimal overhead suitable for real-time applications

(76) Inventors: Michele Zampetti Dale, Quakertown, PA (US); Farrukh Amjad Latif, Lansdale, PA (US); Harold Joseph Wilson, Center Valley, PA (US)

Correspondence Address: HITT GAINES & BOISBRUN P.C., P.O. BOX 832570, RICHARDSON, TX, 75083, US

(21) Appl. No.: 09/861,106

(22) Filed: May 18, 2001

(51) Int. Cl. H04L 12/50

(52) U.S. Cl. 370/386; 370/369

(57) ABSTRACT

A high-speed area-efficient cross bar switch architecture is embedded on a chip to provide connections between a plurality of ports such that multiple and concurrent point-to-point connections may be established between any devices connected to the cross bar. The cross bar is especially well adapted for distributed communication systems implemented as a system on chip. A protocol system ensures that high priority data flows through the cross bar ahead of lower priority data in the event that there are two or more devices concurrently attempting to send data to the same port. The protocol system also arbitrates between two or more devices concurrently attempting to send data to the same port, if data from such sending devices have equal priorities. In a distributed system, concurrency of transmitting and sending data can provide significant performance advantages, as semaphores and notifications are accomplished quickly. Data transfers experience minimal blocking and throughput degradation. No storage for data is necessary in the cross bar due to its light weight protocol for communication between devices, which also alleviates latencies.

### CROSS-REFERENCE TO RELATED APPLICATIONS

This patent application is related to the following pending applications, which (i) are assigned to the same assignee as this application; (ii) were filed concurrently with this application; and (iii) are incorporated herein by reference as if set forth in full below:

Attorney Docket No. TELG-0001, U.S. application Ser. No. ______, entitled “Distributed Communication Device And Architecture For Balancing Processing of Real-Time Communication Applications” to Michele Zampetti Dale, et. al.

Attorney Docket No. TELG-0004, U.S. application Ser. No. ______, entitled “System And Method For Providing Non-Blocking Shared Structures” to Michele Zampetti Dale, et. al.

Attorney Docket No. TELG-0011, U.S. application Ser. No. ______, entitled “Dynamic Resource Management And Allocation In A Distributed Processing Device” to Michele Zampetti Dale, et. al.

Attorney Docket No. TELG-0018, U.S. application Ser. No. ______, entitled “System and Met hod for Coordinating, Distributing and Processing of Data” to Stephen Doyle Beckwith, et. al.

### TECHNICAL FIELD OF THE INVENTION

The present invention is directed, in general, to communication data processing, and more specifically, to a cross bar employable in a distributed processing system embedded on a chip.

### BACKGROUND OF THE INVENTION

Increasing demands for communication speed and capacity have created a need for higher performance processing chips that can effectively handle large amounts of unicast and/or multicast data communication traffic in real-time. Most traditional devices attempt to solve this problem using traditional computer architecture systems that employ ill-suited technology borrowed from data processing environments.

Such systems typically use bus structures. A bus provides only one path for transfer of data. If multiple devices connected to the bus attempt to transfer data at the same time, each must wait their turn until they are granted clear access to the bus. With only one transfer being active at any instant in time, bottlenecks and delays occur and propagate as communication data flows in and out of the system.

Moreover, besides acting as a bottleneck, busses also cause devices to have to deploy costly storage for holding data while waiting for a bus to clear. In a real-time communication environment, such storage further slows performance of the system often to unacceptable levels. Additionally, the need to buffer data substantially increases overhead costs.

For systems that employ high-speed internal busses, any changes to system devices often force load tuning and parasitic adjustments to be performed to the bus structure when the device is re-spun or a derivative product is produced that is based on new process technology and changes in loads (because of more/less devices on the bus). This slows the migration process and forces designers to often design new architecture footprints for new communication systems each time upgrades are made.

Still another problem associated with many communication processing chips is their reliance on a master processor. Most traditional communication processing systems maintain a master-slave relationship requiring the master to regulate (or throttle) most aspects of system functionality. This creates additional bottlenecks in addition to traditionally expensive master processors to regulate the system.

What is needed is a cost-effective solution to relieve bottlenecks in communication processing systems integrated on chips to enable devices therein to communicate more efficiently, on a peer-to-peer basis.

### SUMMARY OF THE INVENTION

To address the above-discussed deficiencies of the prior art, the present invention provides a communication system, that has a plurality of transmitting and receiving devices implemented on a processing chip. A cross bar is embedded on the processing chip to interconnect the transmitting and receiving devices, thereby enabling point-to-point connections between each of the devices. The cross bar is configured to pass data between the transmitting devices and the receiving devices when the receiving device is available to receive the data. There is no requirement to buffer data in the cross bar once the receiving device is available to receive data.

In another embodiment, a high-speed area-efficient cross bar switch architecture is embedded on a chip to provide connections between a plurality of ports, such that multiple and concurrent point-to-point connections may be established between any devices connected to the cross bar. The cross bar is especially well adapted for distributed communication systems implemented as a system on chip. A protocol system ensures that high priority data flows through the cross bar ahead of lower priority data in the event that there are two or more devices concurrently attempting to send data to the same port. The protocol system also arbitrates between two or more devices concurrently attempting to send data to the same port, if data from such sending devices have equal priorities. In a distributed system, concurrency of transmitting and sending data can provide significant performance advantages, as semaphores and notifications are accomplished quickly. Data transfers experience minimal blocking and throughput degradation. No storage for data is necessary in the cross bar, which alleviates latencies.

The present invention therefore introduces the broad concept of embedding a cross bar on a communication chip system to provide point-to-point communication between devices forming the system. No storage of data is needed in the cross bar, which reduces costs and increases performance. Thus, the present invention provides a robust cross bar able to be implemented as part of a system on a chip. The cross bar is efficient in terms of area, functionality and overhead permitting a robust distributed processing system to be implemented on an integrated chip. The present invention also eliminates the need to rely on a multiple bus structure on a processing chip. Due to the cross bar's efficiency, it does not have to reside on its own dedicated chip in a multi-chip communication system (although more than one chip can be interconnected via the cross bar).

Additionally, an efficient protocol for exchange of information is enforced by the cross bar to ensure continuous data. In one embodiment, data is automatically sent to a receiving device from a source, if that receiving device previously requested it. This eliminates handshaking routines and delays associated with availability checks.

Furthermore, if contention exists for a given port, arbitration takes place to allow higher priority data to be sent first. Other arbitration techniques can be used depending on the system and type of data being sent. For example, if data has equal priority, a fairness routine may be implemented granting access to data on a round-robin basis. Of course, it is envisioned that other routines may be employed.

Another feature and advantage of the present invention is the ability to provide multiple concurrent paths between any two devices on a chip that desire to communicate with each other at any time.

A further feature and advantage of the present invention is the ability to route data immediately without delays. No storage is employed in the cross bar to reduce delays associated with registers and stores. Additionally, complicated switching arrangements are avoided, eliminating costs associated with semaphores, object ownership control units and complicated handshaking routines.

Still another feature and advantage of the present invention is the ability to provide point-to-point connections between devices on a chip and with devices off-chip via ports on the cross bar. Since the cross bar supports multiple protocol primitives, true peer-to-peer communication is supported by the cross bar in a distributed system. Point-to-point connections between devices via the cross bar also facilitates migration to new process technology as it becomes available. This eliminates the need for load tuning that would generally be required on a high-speed system bus when the device is re-spun or a derivative product is produced based on a new process technology.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 shows a multi-protocol environment that a communication device may be employed, in accordance with one embodiment of the present invention;

FIG. 2 is a block diagram of a communication device according to an illustrative embodiment of the present invention;

FIG. 3 shows a more detailed view of a cross bar according to an illustrative embodiment of the present invention;

FIG. 4 shows a flow diagram introducing the operational flow of a protocol system implemented as part of the request and arbitration/control logic of a cross bar according to an exemplary embodiment of the present invention; and

FIG. 5 shows a sample format of a Control Word, according to one embodiment of the present invention.

### DETAILED DESCRIPTION

The following description is presented to enable a person skilled in the art to make and use the invention, and is provided in the context of a particular application and its requirements. Various modifications to the preferred embodiment will be readily apparent to those skilled in the art and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The preferred embodiments of the invention are now described with reference to the FIGUREs where like reference numbers indicate identical or functionally similar elements. Also in the FIGUREs, the leftmost digit of each reference number corresponds to the FIGURE in which the reference number is first used.

The present invention may be used in almost any application that requires real-time speed and/or processing efficiency. It is envisioned that the present invention may be adopted for various roles, such as routers, gateways and I/O processors in computers, to effectively transmit and process data, especially streaming media. One feature of the present invention is its ability to be applied in an integrated chip environment where a need exists to support transmission and receipt of real-time data in a distributed system.

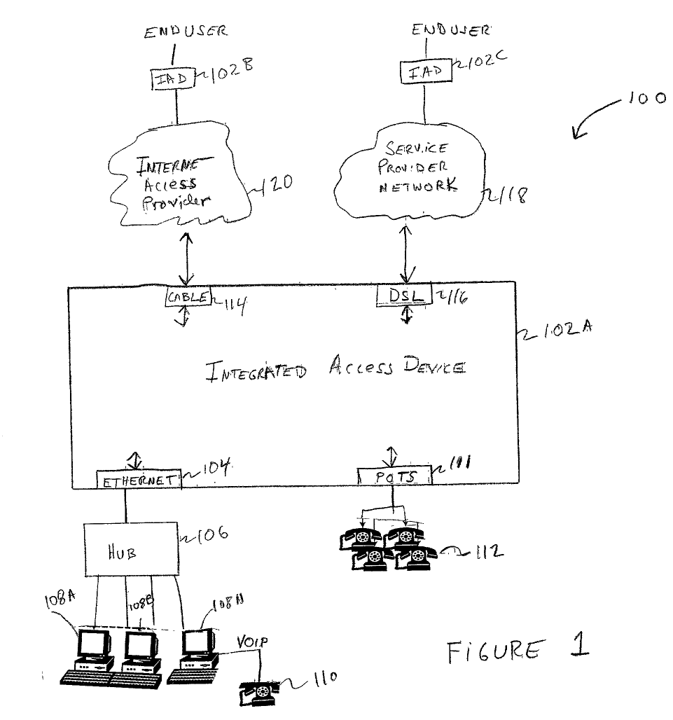

FIG. 1 shows a multi-protocol environment 100 where a communication device 102 may be employed, in accordance with one embodiment of the present invention. In this example, communication device 102 is an integrated access device (IAD) that bridges two networks. That is, IAD 102 concurrently supports voice, video and data and provides a gateway between other communication devices, such as individual computers 108, computer networks (in this example in the form of a hub 106) and/or telephones 112 and networks 118, 120. In this example, IAD 102A supports data transfer between an end user customer's site (e.g., hub 106 and telephony 112) and Internet access providers 120 or service providers' networks 118 (such as Sprint Corporation and AT&T). More specifically, IAD 102 is a customer premise equipment device supporting access to a network service provider.

Nevertheless, it is envisioned that IAD 102 may be used and reused in many different types of protocol gateway devices, because of its adaptability, programmability and efficiency in processing real-time data as well as non-real-time data. As will become appreciated to one skilled in the art, the architecture layout of device 102 (to be described in more detail below) may well serve as a footprint for a wide variety of communication devices including computers.

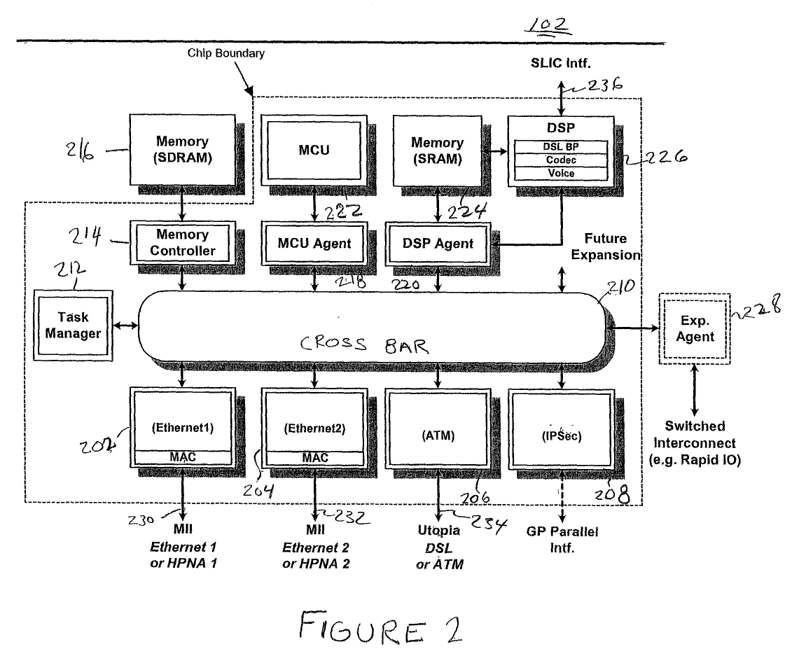

FIG. 2 is a block diagram of device 102 according to an illustrative embodiment of the present invention. Device 102 is preferably implemented on a single integrated chip to reduce cost, power and improve reliability. Device 102 includes intelligent protocol engines (IPEs) 202-208, a cross bar 210, a function allocator (also referred to as a task manager module, or TMM) 212, a memory controller 214, a micro unit (MCU) agent 218, a digital signal processor agent 220, a MCU 222, memory 224 and a DSP 226.

External memory 216 is connected to device 102. External memory 216 is in the form of synchronized dynamic random access memory (SDRAM), but may employ any memory technology capable of use with real-time applications. Whereas internal memory 224 is preferably in the form of static random access memory, memory 224 may be any memory with fast access time may be employed. Generally, external memory 216 is unified (i.e., MCU code resides in memory 216 that is also used for data transfer) for cost-sensitive applications, but local memory may be distributed throughout device 102 for performance sensitive applications such as internal memory 224. Local memory may also be provided inside functional blocks 202-208, which shall be described in more detail below.

Also shown in FIG. 2 is an expansion port agent 228 to connect multiple devices 102 in parallel to support larger hubs. For example, in a preferred embodiment, device 102 supports four POTS, but can be expanded to handle any number of POTS, such as a hub. Intelligent protocol engines 202-208, task manager 212 and other real-time communication elements such as DSP 226 may also be interchangeably referred to throughout this description as “functional blocks.”

Data enters and exits device 102 via lines 232-236 to ingress/egress ports in the form of IPEs 202-206 and DSP 226. For example, voice data is transmitted via a subscriber line interface circuit (SLIC) line 236, most likely located at or near a customer premise site. Ethernet-type data, such as video, non-real-time computer data and voice-over-IP, is transmitted from data devices (shown in FIG. 1 as computers 108) via lines 230 and 232. Data sent according to asynchronous transfer mode (ATM), over a digital subscriber line (DSL), flow to and from service provider's networks or the Internet via port 234 to device 102. Although not shown, device 102 could also support ingress/egress to a cable line (not shown) or any other interface.

The general operation of device 102 will be briefly described. Referring to FIG. 2, device 102 provides end-protocol gateway services by performing initial and final protocol conversion to and from end-user customers. Device 102 also routes data traffic between an Internet access/service provider network 118, 120 (shown in FIG. 1). MCU 222 handles most call and configuration management and network administration aspects of device 102. MCU 222 also performs low priority and may perform non-real-time data transfer for device 102, which shall be described in more detail below. DSP 226 performs voice processing algorithms and interfaces to external voice interface devices (not shown). IPEs 202-208 perform tasks associated with specific protocol environments appurtenant to the type of data supported by device 102 as well as upper level functions associated with such environments. TMM 212 manages flow of control information by enforcing ownership rules between various functionalities performed by IPEs 202-208, MCU 222 or DSP 226.

Most data payloads are placed in memory 216 until IPEs 202-208 complete their assigned tasks associated with such data payload and the payload is ready to exit the device via lines 230-236. The data payload need only be stored once from the time it is received until its destination is determined. Likewise time-critical real-time data payloads can be placed in local memory or buffer (not shown in FIG. 2) within a particular IPE for immediate egress/ingress to a destination or in memory 224 of the DSP 226, bypassing external memory 216. Most voice payloads are stored in internal memory 224 until IPEs 202-208 or DSP 226 process control overhead associated with protocol and voice processing respectively.

A cross bar 210 permits all elements to transfer data at the rate of one data unit per clock cycle without bus arbitration further increasing the speed of device 102. Cross bar 210 is a switching fabric allowing point-to-point connection of all devices connected to it. Cross bar 210 also provides concurrent data transfer between pairs of devices. In a preferred embodiment, the switch fabric is a single stage (stand-alone) switch system, however, a multi-stage switch system could also be employed as a network of interconnected single-stage switch blocks. For most real-time applications a crossbar is preferred for its speed in forwarding traffic between ingress and egress ports (e.g., 202-208, 236) of device 102.

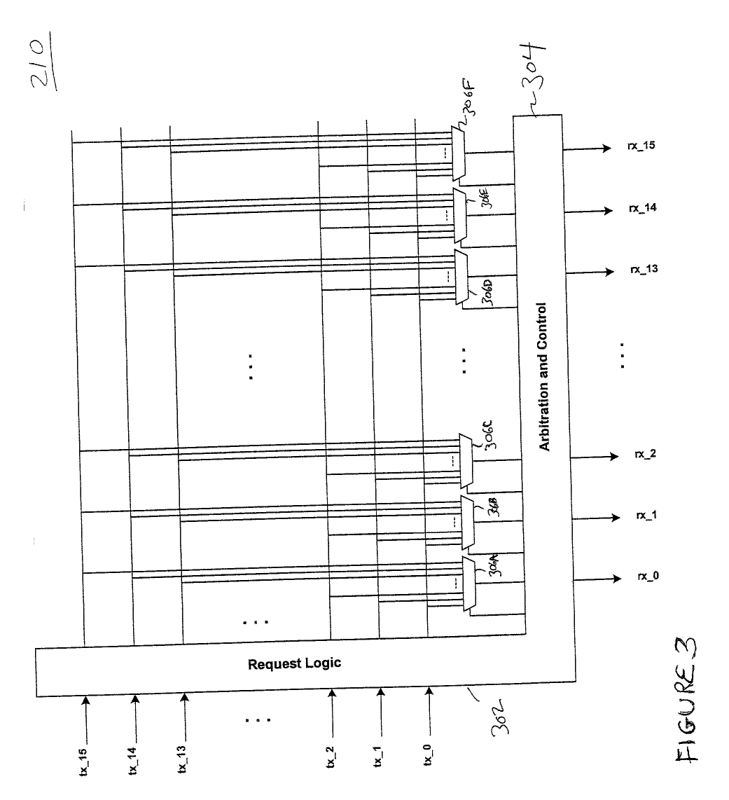

FIG. 3 shows a more detailed view of cross bar 210 according to an illustrative embodiment of the present invention. In this illustrative embodiment, cross bar 210 consists of eight ports, each having an ingress (transmit, tx) and egress (receive, rx) sub-port for full duplex operation. That is, there can be simultaneous transfer of input and output data in each port. So cross bar 210 provides multiple concurrent paths between any two different devices that desire to communicate with each other.

It is envisioned that larger port sizes can be selected depending on the application. For example, in one contemplated implementation, cross bar 210 will support 16 ports with each sub-subport (tx or rx) supporting a 32-bit wide word.

Each transmit tx port can send information to any receive port rx. So any transmitter device (e.g., IPE 202-208, MCU 222, etc.) can generate a request from its assigned port to any receive ports rx. A “request” as used herein generally refers to transmitting a message to another device by initiating a request.

Accordingly, cross bar 210 provides multiple and concurrent point-to-point communication paths between IPEs 202-208, MCU 222, DSP 226, TMM 212, external memory 216 and any other intelligent device (e.g., IPE) or slave device (e.g., external memory) that may be connected internally to cross bar 210 or externally through an expansion port (shown in FIG. 2).

In a distributed system, such as shown in FIG. 2, this concurrency of communication can provide significant performance advantages as control information, semaphores and notifications are accomplished quickly. Thus, transfer of data experiences minimal blocking, reduced throughput degradation and minimal latency.

Referring to FIG. 3, request logic 302 and arbitration/control logic 304 permit a transmitting device to send data via a transmit port tx to any receiving device via a receive port rx. As will be described in more detail below, request logic 302 and arbitration/control logic 304 form part of a protocol system that is configured to ensure that data is transferred on the-fly without the need for storage of data in buffers, FIFO buffers, registers and the like. So, once data is transmitted from a device it is directly routed to its destination device via a point-to-point connection actualized by cross bar 210. Multiplexers 306 select communication paths between transmit and receive ports (tx, rx) once arbitration/control 304 determines that a particular receive port rx is ready for transmission. Request logic 302 and arbitration/control logic 304 are implemented through combinatorial logic (or via a state machine in firmware) to ensure suitable speed. Those skilled in the art will readily appreciate how to configure request logic 302 and arbitration control logic 304 to carry out the operations of a particular protocol system. Details of particular logical gates will need to be generated on a case-by-case design depending on a particular implementation of the communications system 102.

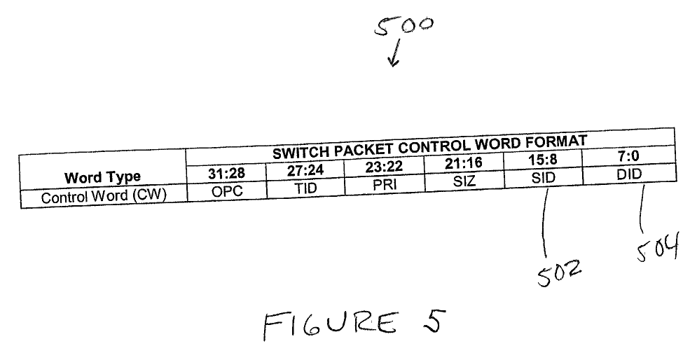

Each message sent in the system through cross bar 210 typically employs a control word, which is described in more detail below with reference to FIG. 5. The destination ID provides information necessary to indicate where to send a message. So, a sending device (i.e., transmitting device) connected to cross bar 210 provides destination information in the form of a destination ID. Each device connected to cross bar 210 has a unique ID, which can be assigned at initialization through programmable firmware in the devices.

When a request is made to send a message to a destination through cross bar 210, the requester issues a transmit request. The destination ID (504 of FIG. 5) of the transmit request message control word 500, is compared against all device IDs visible to cross bar 210. Once a match is made via combinatory control logic, the transmit request is forwarded to the port of the cross bar 210 that will service it, i.e., the receive port rx shown in FIG. 3. If a match is not made, then cross bar 210 assumes that the message is destined to an off-chip device and the message is routed through an expansion port 211 shown in FIG. 2. It is assumed throughout the discussion below, that each time a message is sent, a match is made via combinatory control logic before any other processing by cross bar 210 occurs.

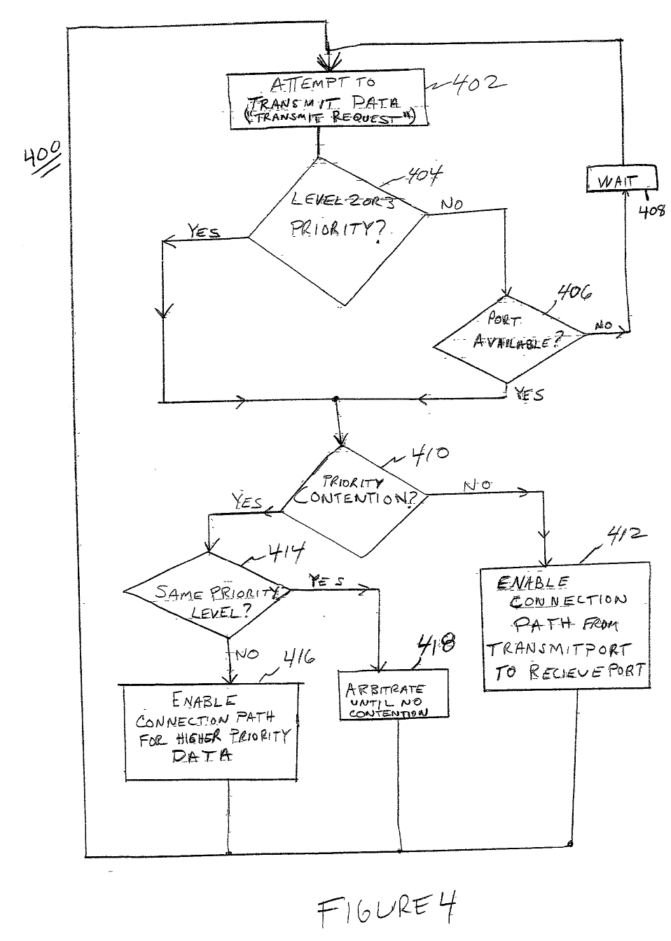

FIG. 4 is a flow diagram introducing the operational flow of a protocol system 400 implemented as part of request and arbitration/control logic 302, 304 of cross bar 210, according to an exemplary embodiment of the present invention. Protocol system 400 enforces flow control and arbitration between devices connected to cross bar 210. Protocol system 400 includes steps 402-418 and represents one way in which data may be routed and prioritized according to one embodiment of the present invention. Those skilled in the art should readily appreciate that other protocol paradigms can easily be adopted for other systems, depending on the size and application of cross bar 210. Therefore, protocol system 400 is one of many ways to ensure simple, but eloquent control and flow of data in a distributed communication processing environment.

It should also be noted that if a particular message path between a receive and transmit port is busy due to the sending of a message, any other devices attempting to transmit to the same receive port will be halted until the transmission is complete. Therefore, when reference is made to “port available?” in decisional step 406 below, this is a situation where the receiving device sends receiving device is full and its buffers cannot except any data, unless its of a higher priority (to be described). This is referred to as a flow control situation, as opposed to a message busy situation, when a message is currently en route and should not be interrupted. With that clarification in mind, protocol system 400 will now be described.

Referring to FIG. 4, in step 402 a high level device, such as an IPE attempts to transmit data to another high level device connected to cross bar 210. Data may be in the form of a message, control word or a data payload. Data is almost always packetized and has various classes of priority assigned to it. In a preferred embodiment, there are four levels or priority associated with data to be transmitted. “Level 0” is associated with most operations and is regular priority. “Level 1” is assigned to data having a higher priority level of traffic than level 0. “Level 2” is higher priority than levels 0 and 1, and is associated with normal messages and/or responses that need to be precessed ahead of normal data. Finally, “level 3” is the highest priority associated with critical command and data flow, including high priority messages. Of course, many other different priority levels can be implemented and tailored for a particular implementation. Thus, the aforementioned levels should be viewed as exemplary and without limitation.

Each device, such as IPEs 202-208 and MCU 222, is able to assign a priority level to control words associated with packets of data based on the nature of the message or data. Priority levels are assigned to payloads and messages to achieve the desired performance of a particular system and avoid deadlock. Thus, higher-levels are assigned to more critical data operations to elevate such operations over others and increase bandwidth allocation.

So, in step 402, if a device attempts to send data to another device (e.g., IPE 202 to memory 216), a level from 0 to 3 is assigned to the transaction associated with the data. So, part of protocol system 400 is the ability for device(s) at some point to intelligently assign levels of priority to data to be sent. Cross bar 210, in this embodiment has no control over assignment of priority levels.

Next, in a decisional step 404, cross bar 210 examines control portions of a data packet to be sent by a transmitting device via a transmit port tx to determine its level. If data is not a level 2 or 3 priority, then the “NO” branch of decisional block 404 is taken.

Accordingly, in a decisional step 406, cross bar 210 determines whether a receive port rx associated with the device to receive data is available. This is a flow control issue and whether a device located at the receive port has enough room to accept data. If the particular receive port is full or unavailable, then the device attempting to send the data is sent a signal (not shown) by request logic 302 to wait until the port rx becomes available, as done in step 408. Typically, simple combinatory logic in request logic 302 determines whether a receive port rx is available. Request logic 302 does not check to see whether a receive port rx is available if data has a higher priority level than a level 0 or 1. As described above, priority 2 & 3 data always goes through.

So, level 2 or level 3 data bypasses steps 406 and 408, because inherent in protocol system 400, is the assumption that data with either associated levels 2 and 3, was either previously requested by a requesting device (making the port unavailable to lower priority data) or the message is so critical that the receiving device can accept it. So, even if a receive port rx is “unavailable” to level 0 or 1 data, it is assumed by protocol system 400 that the device connected to the particular receive port rx can accept data with associated levels 2 or 3. Thus, regardless of port availability steps 406 and 408 are ignored and the “YES” branch of decisional block 404 is chosen if the data has a level 2 or higher priority.

Next, in a decisional step 410, if the receive port rx is available, or the data has a level 2 or 3 priority, protocol system 400 determines whether there are more than one transmitting devices (such as IPE 202 and IPE 204) attempting to concurrently send data to a receiving device (such as IPE 206). In other words, if there is contention for the identical receive port rx by two or more devices, arbitration/control 304 must invoke some type of arbitration protocol to avoid deadlock. Of course, if there is no contention in an idealized situation, then according to the “NO” branch of decisional block 410, a point-to-point communication path is granted for data to be sent from a transmitting device to a receiving device via cross bar 210. Thus, arbitration/control 304, using combinatory logic in cross bar 210, performs a contention check, and if necessary, arbitration when there is a contention state for the same port by more than one device.

If contention occurs, then, according to the “YES” branch of decisional block 410, arbitration/control 304 determines if the contending data at the multiple transmit ports tx, have the same priority levels. For instance, if IPE 202, via transmit port tx_{—}7 is attempting to send level 0 priority level data to IPE 206 at receive port rx_{—}1. While at the same time, IPE 204 via transmit port tx6 is attempting to send level 2 priority to IPE 206 at port rx_{—}1. Then, there is not the same level of priority for data to be sent and the “NO” branch of a decisional block 414 is selected.

Next, in step 416, arbitration/control 304 selects mux 306B to enable a direct point-to-point communication path for the flow of data from IPE 204 at port tx_{—}6 to IPE 206 at receive port rx_{—}1.

On the other hand, referring to the aforementioned example, if IPEs 202 and 204 both attempt to send the same level 2 priority data concurrently, then the “YES” branch of decisional block 414 is selected. In this case, in step 418, arbitration/control 304 performs arbitration until there is no contention for the same port. Typically, a fairness arbitration routine is preferred to ensure that each device vying for the same port has a fair chance of sending data if contending for the same device. One routine that ensures fairness is a round-robin fairness arbitration routine that selects contending devices on prescribed order the first time a contention occurs. So, arbitration/control 304 may first select IPE 202 to send data, then enable IPE 204 to send data. So, round-robin fairness arbitration prevents deadlocks and encourages fairness when there is priority level contention between devices.

However, the next time there is contention arbitration/control 304 will remember that IPE 204 was selected last. To ensure true fairness, IPE 204 will be provided access to send its data first, the next time contention for the same port occurs, since IPE 204 was last the previous time contention existed. Arbitration/control 304 may use some storage to save the history states of previous arbitration outcomes. Of course, this storage can easily be implemented with minimal costs using only a few registers. In no way is this storage intended for data packets being transferred in cross bar 210. There are four levels of round-robin arbitration states maintained for each egress tx or receive port rx. Of course, present implementation is not meant to limit the scope of the present invention as any type of arbitration or non-arbitration scheme could be used in the event of conflict.

Now, that the general operation of protocol system 400 and cross bar 210 have been described, a more detailed description of cross bar 210, protocol system 400 is provided below. Prior to sending data a requester (i.e., a device attempting to transmit data) sends a transmit request to cross bar 210. The transmit request consists of a Control Word (CW) including the destination ID of the port to receive the data. The destination ID is compared against all local port IDs (e.g., the programmed port IDs rx_{—}0 to rx_{—}15) visible to the requesting transmit port tx. Once a match is found and priority and arbitration is resolved as described above, then the transmit request is connected to destination port rx of cross bar 210.

The basic protocol 400 relies on both logical and physical flow control. Cross bar 210 typically only enforces physical level flow control, whereas it is the responsibility of the devices connected to cross bar 210 to enforce logical flow control. Cross bar 210 automatically accepts packets if the destination can receive a complete packet or the packet has a priority of level 2 or 3. In other words, except for arbitration contention of multiple Transmit Requests, priority levels 2 and 3 Transmit Requests are non-blocking through cross bar 210.

Cross bar 210 enforces hardware flow control priority level 0 and 1 requests; this hardware flow control is on a packet transfer basis and is not intended to throttle the packet transfer on a per word basis. In the case where slave devices (e.g., memory devices) are the destination end point, Transmit Requests of priority level 2 or 3 are not preferred. This ensures that these types of requests are not discarded, since slave devices will typically only support physical flow control and level 2 and 3 requests may overflow the requesters queue. As a result, a “fail response” message may be triggered by the slave device.

A packet sent from one processing element to another in FIG. 2 is routed by cross bar 210 by interpreting the header on a packet (to be described). All packet transfers consist of a header (Control Word, or CW) followed by 1 to “n” additional words (determined by the CW “Size” field). The header information contains both the source and destination IDs. FIG. 5 shows a sample format of a CW 500, according to one embodiment of the present invention. CW 500 includes an operation code (OPC), a tag ID (TID), a priority level (PRI), a size (SIZ), a source ID (SID) and a destination ID (DID). When the destination of a request packet generates a response packet, it simply swaps the source ID and destination ID fields from the request, making the original source the new destination and itself the source.

The tag ID facilitates split transactions from each requester. Split transactions are accomplished by associating tags with each transaction. Cross bar 210 does not provide ordering guarantees. Ordering of a transaction is the responsibility of a receiving device.

To enable routing, cross bar 210 requires all processing elements in system 102 to have unique IDs. Cross bar 210 may be implemented with a table (not shown), distributed table (not shown) or other configuration method that instructs cross bar 210 how to route every destination ID from a transmit port tx to the proper receive port rx. Table implementations are known to those skilled in the art. The simplest form of this method allows only a single point-to-point data path from every device connected to cross bar 210 in FIG. 2. It is envisioned, however, that more complex forms of this method can allow adaptive routing or redundancy and congestion relief.

As mentioned above with respect to FIG. 3, each port has ingress tx and egress rx subports for full duplex operation. All ports may be identical in pin-out and functionality. One port can be reserved for a cross bar maintenance to configure cross bar 210 and set up various connection modes.

Even though all ports are physically available, depending on a design they don't all have to be used. Unused ports may be strapped or configured as “disabled.” Thus, for a 16 port cross bar 210 one advantage of the enable/disable feature is that unused ports need not consume any of the 256 supported Port IDs available within the cross bar. Of course, a 16 port cross bar is described for illustrative purposes, and the actual number of port IDs available and the size of a cross bar may vary depending on the application.

Cross bar design allows ports to be “bonded” for a wider cross connection to other bonded ports. Bonded or aggregated ports use only one port ID address within the cross bar 210. Each port interface has a static signal that indicates to the port control/arbitration 304 that such a port is used as a bonded “slave” port, hence disabling the port's arbitration logic. Naturally, those skilled in the art appreciate that the usage of bonded ports assumes the processing element connected to such bonded port has an appropriate queue structure to support both standard 32-bit wide transfers and the bonded wider width transfers, for example 64 bits. Memory controller 214 of FIG. 2 and DSP agent 220 have an appropriate queue structure and therefore are connected to cross bar 210 as bonded port pairs (64-bits in width). Other widths could easily be adopted depending on the application.

In addition to the port interface signals mentioned above, each port in one embodiment, has 32 bit control/address/data lines, physical control, a packet delineation signal, port ID pins, handshaking signals and several information bits. Port ID pins are driven continuously from the device connected to the respective port. As used herein pins refer to specific transmit and receive ports in FIG. 3.

As previously mentioned, cross bar 210 provides multiple concurrent paths between many pairs of requesters (e.g., devices). These concurrent paths are provided in a crossbar type arrangement. The routing technique implemented in an illustrative embodiment is to support crossbar connections is a simple, fast, cost effective solution based on a Request ID Comparison technique.

Request ID Comparison-based routing relies on each port providing its ID to cross bar 210. When a requester issues a Transmit Request, the destination ID in the request Control Word (CW) is compared against all port IDs visible to the Switch port. Note, if a Port is not enabled, its port ID is not visible to the other Ports of the Switch. Once a match is found, a request is made, the priority and arbitration is resolved and the Transmit Request Control Word is connected to the destination port rx of cross bar 210 that will service it.

Request ID Comparisons are performed at each Transmit sub-port while priority resolution and arbitration is performed at each receive sub-port of cross bar 210 via arbitration/control 304. All the Transmit Requestors requesting service from a given Rx sub-port are presented to that port, the priority of each is checked and round-robin fairness arbitration is invoked to determine which transmit port will be granted access. Once the transmit port is selected, a grant or connection indication is issued to the selected transmit port tx. This completes the communication path within cross bar 210.

If a local match is not found, the “else” condition of the comparison is executed. The “else” condition selects the Expansion port (shown in FIG. 2); thus, all traffic not destined for the local switch domain is routed to the Expansion port.

The routing method described above requires cross bar 210 to be tightly coupled (i.e., sources and destinations must be local). Hence, it is preferred that cross bar 210 be internal to a chip. The main advantage of this scheme is low cost for a small number of ports and a small number of destination IDs. This method provides excellent clock speed performance for 16 or fewer ports.

As mentioned above, in the event that several requests and CWs have the same priority and Destination ID, protocol system 400 will implement a round-robin fairness arbitration algorithm to ensure that all sources have equal access to the addressed destinations.

The arbitration takes place at each egress Switch sub-port rx. In fact, there is a unique arbiter (implemented in combinatory logic and shown as control/arbitration 304) per port and each arbiter has multiple tiers or round-robin states of arbitration, one for each priority class. The arbitration state for each priority class request that is granted a connection is saved and used in the next round-robin fairness arbitration sequence of the same priority class for the respective port.

Arbitration may be implemented in many different ways and should not be limited to round-robin fairness arbitration. For example, certain devices may always receive preference over other devices in the event of a simultaneous same class contention. Many other types of arbitration, too numerous to list here, could be selected by those skilled the art to deal with class contentions.

Four fixed priority classes are supported via the 2-bit priority field in the Control Word. The priority classes are used to elevate certain transactions over others both for bandwidth allocation and deadlock avoidance. The source device can use higher-level algorithms to increase or decrease the priority levels of certain payloads to achieve the desired performance.

Protocol system 400 relies on both logical and physical flow control. Cross bar 210 enforces physical level flow control; it is the responsibility if the processing devices connected to cross bar 210 to enforce logical flow control. Cross bar 210 will only accept packets if the destination can receive a complete packet or the packet has a priority level of 2 or 3.

Priority level 2 or 3 packets are forwarded to the destination irrespective of the physical flow control. Priority level 3 packets contain critical messages or time critical data, while Priority level 2 packets consist of responses or messages. Responses require that the destination have space for the packet (logically this must be true since the destination made the request) and hence must be accepted. Messages are always accepted by the destination. If there is a message overflow condition in the device, it will be interpreted as a fatal error condition for that device.

Incoming packets having a priority level of 0 or 1 are accepted by cross bar 210 and forwarded to the destination dependent on the physical flow control. Physical flow control is a combination of contention resolution with other requesters attempting to send packets of the same priority to the same Destination ID port and a packet based handshaking protocol where the destination processing element signals to the source that it is capable of accepting a complete packet.

A slave device or non-intelligent processing element, such as a Memory Controller 214, connected to cross bar 210 relies entirely on physical flow control. It will accept all read and write request packets sent by various requesters and only assert flow control when its internal queue (not shown) is full and cannot accept any new requests.

Flow control is invoked on a packet basis; therefore, the device must have enough storage to take in a complete max size Write Request if a physical flow control is not invoked. If a packet of priority level 2 or 3 is transferred to a slave destination device and the slave destination device has a full input queue, the packet will be dropped. In this situation, it is possible for the slave destination device to send a fail response back to the source.

As shown in FIG. 5, all packet transfers consist of a Control Word followed by one to five (configurable to as many as nine, in the illustrated embodiment) additional words (determined by the CW “Size” field). Protocol 400 actually allows packet transfers to comprise a Control Word followed by one to 15 additional words, but due to system and hardware considerations, the packet based flow control described herein is programmable such that the maximum size packet transfer can be changed (configurable to a maximum of 10, in this embodiment).

When the destination of a request packet generates a response packet, the device responding to the request, simply swaps the source ID 502 with the destination ID 504 from the request, making the original source the new destination and itself the new source. Although the present invention has been described in detail, those skilled in the art should understand that they can make various changes, substitutions and alterations herein without departing from the spirit and scope of the invention in its broadest form.

What is claimed is:

1. A communication system, comprising:
a plurality of transmitting and receiving devices;
a processing chip; and
a cross bar embedded on said chip, interconnected to said transmitting and receiving devices, that provides a point-to-point connection between each of said devices, wherein said cross bar is configured to pass data between at least one of said transmitting devices and at least one of said receiving devices when said receiving device is available to receive such data and without a requirement to buffer said data in said cross bar.

2. The communication system of claim 1, wherein said cross-bar provides multiple concurrent paths between said plurality of transmitting and receiving devices to support concurrent transmission and reception of data.

3. The communication device of claim 1, wherein said cross bar is integrated on said processing chip.

4. The communication device of claim 1, wherein at least one of said transmitting and receiving devices is intelligent.

5. The communication device of claim 1, wherein said cross bar checks whether said receiving device is available to accept data before granting access for said transmitting device to send data to said receiving device.

6. The communication device of claim 1, wherein said cross bar grants unrestricted access for said transmitting device to send data to said receiving device, if said receiving device previously requested data from said transmitting device and said request for data has not been fulfilled.

7. The communication device of claim 1, wherein said cross bar performs arbitration if more than one transmitting device attempts to concurrently send data to the same receiving device.

8. The communication device of claim 7, wherein said cross bar selects one of said transmitting devices to concurrently send data to the same receiving device, if data from one of said transmitting devices has a higher priority level than data attempting to be concurrently sent from any other of said transmitting devices.

9. The communication device of claim 8, wherein said cross bar performs round-robin fairness arbitration if said multiple transmitting devices are attempting to send data with identical priority levels to the same receiving device.

10. The communication device of claim 1, wherein said transmitting and receiving devices are functional blocks in a distributed communication device.

11. The communication device of claim 10, wherein at least one of said functional blocks is a digital signal processor.

12. The communication device of claim 10, wherein at least one of said functional blocks is a programmable microprocessor.

13. The communication device of claim 10, wherein at least one of said functional blocks is a processor.

14. The communication device of claim 1, wherein at least one of said receiving devices is memory.

15. A processing system, comprising:
a communication processing chip containing a plurality of devices that can send and receive data;
a cross bar switch architecture, embedded on said chip, having a plurality of ports interconnecting said plurality of devices such that multiple and concurrent point-to-point communication paths may be established between any of said devices connected to said cross bar switch; and
a protocol system configured to:
(a) establish a communication path between two of said devices if a port associated with receiving data is available, and
(b) arbitrate if multiple devices are contending with each other to concurrently send data to an identical port, by granting access to one of said multiple devices that is attempting to send data with a higher priority level than data from any another device concurrently contending for said identical port,
whereby data can flow directly and without the need for buffering in said cross bar switch architecture once said communication path is established between devices.

16. The processing system of claim 15, further comprising an expansion port, connected to said cross bar, configured to provide a communication path between devices external to said chip.

17. The processing system of claim 15, wherein said devices that receive and send data include:
an intelligent microprocessor,
a processor,
a digital signal processor,
a controller, and
a memory.

18. The processing system of claim 15, wherein said processing system is a distributed processing system.

19. The processing system of claim 15, wherein said protocol system is further configured to arbitrate in a round-robin fashion if priority levels of data from said multiple contending devices have equal priority levels.

20. A system interconnect for interconnecting a plurality of devices on a chip that can send and receive data, comprising:
a cross bar switch architecture, embedded on said chip, having a plurality of ports interconnecting said plurality of devices such that multiple and concurrent point-to-point connection may be established between any of said devices connected to said cross bar switch; and
a protocol system configured to automatically establish a point-to-point connection between two of said devices if a request was previously made to receive data from a source, whereby there is no need to store data within said cross bar to enable said protocol system to connect devices.

21. The system of claim 20, wherein said protocol system configured to establish a point-to-point connection between a transmitting and receiving device if a port associated with said receiving device is available to receive data.

22. The system of claim 20, wherein said protocol system configured to arbitrate between more than one device attempting to send data to an identical receiving device concurrently.

23. The system of claim 20, wherein each message sent between devices contain a destination and source identification fields in a control word, wherein said source identification field indicates a source of a message and said destination identification field indicates destination of a message.

24. The system of claim 23, wherein a device that receives a message, swaps said destination and source identification fields when responding to a device that sent said message, such that said control word's destination ID refers to the device which previously sent said message and said control word's source identification refers to said device that previously received said message.
